(19) United States
(12) Patent Application Publication
(10) Pub. No.: US 2015/0021951 A1
(43) Pub. Date: Jan. 22, 2015

(54) COOLING ARRANGEMENT AND METHOD FOR COOLING AN UNDERSIDE VEHICLE COMPONENT

(71) Applicant: Honda Motor Co., Ltd., Tokyo (JP)

(72) Inventors: Michael W. Maurer, Novi, MI (US); Jesse Black, Marysville, OH (US); Xavier Hernandez, Lima, OH (US); Scott Simmons, Pickerington, OH (US)

(21) Appl. No.: 13/944,958

(22) Filed: Jul. 18, 2013

(51) Int. Cl. B62D 35/02

(52) U.S. Cl. CPC B62D 35/02
USPC 296/180.1

(57) ABSTRACT

An underside cooling arrangement and method for a vehicle includes an underside component mounted to the underside of the vehicle, and an airflow directing member that directs airflow generated when the vehicle is moving in a forward direction to a location rearward of the underside component. The airflow that is directed to the location rearward of the underside component creates a vacuum that draws an auxiliary airflow near the underside component for cooling thereof.

### BACKGROUND

The present disclosure generally relates to an underside cooling arrangement and method for a vehicle, and particularly relates to an underside cooling arrangement and method for cooling an underside vehicle component, such as a bracket mounting a vehicle's exhaust pipe to the underside of the vehicle.

All vehicles are being pushed to increase aerodynamics and/or fuel economy. One way to improve aerodynamics on vehicles is to apply aero covers or undercovers to vehicles on undersides thereof. All such undercovers do indeed improve aerodynamics but an undesirable side effect is that the undercovers can trap heat under the vehicle and/or can undesirably increase the temperatures of parts under the vehicle above a desired amount. For example, an underside cover applied in the area through which the vehicle's exhaust pipe passes can undesirably cover a mounting bracket for the exhaust pipe and trap heat therearound. Forcing air straight to such an underside component could potentially reduce the temperature of the underside component, but might also comprise the intent of the undercover in improving the vehicle's aerodynamics.

### SUMMARY

According to one aspect, an underside cooling arrangement for a vehicle includes an underside component mounted to the underside of the vehicle, and an airflow directing member that directs airflow generated when the vehicle is moving in a forward direction to a location rearward of the underside component. The airflow that is directed to the location rearward of the underside component creates a vacuum that draws an auxiliary airflow near the underside component for cooling thereof.

According to another aspect, a method is provided for cooling an underside vehicle component. In accordance with the method, airflow is directed to a location rearward of the underside vehicle component. A vacuum is created at the location with the airflow directed thereto. Cooling air is drawn to the underside vehicle component with the vacuum.

According to a further aspect, a cooling arrangement for an underside of a vehicle includes an underside vehicle component subject to overheating and an airflow directing member directing an airflow on the underside of the vehicle to a location rearward of the underside vehicle component to thereby create a vacuum at the location and draw in auxiliary airflow across the underside vehicle component for cooling thereof.

### BRIEF DESCRIPTION OF THE DRAWINGS

FIG. 1 is a partial schematic underside plan view of a vehicle showing an aero cover mounted over an underside vehicle component.

FIG. 2 is a another partial schematic plan view of the underside of the vehicle, similar to FIG. 1, but showing a breakaway portion of the aero cover and breakaway portions of a frame component to illustrate a primary airflow and an auxiliary airflow.

FIG. 3 is a cross-sectional view taken along the line 3-3 of FIG. 1.

FIG. 4 is another partial schematic underside view of a vehicle, similar to FIG. 1, but illustrating an alternate embodiment in which a duct is applied to the aero cover.

FIG. 5. Is a cross-sectional view taken along the line 5-5 of FIG. 4.

### DETAILED DESCRIPTION

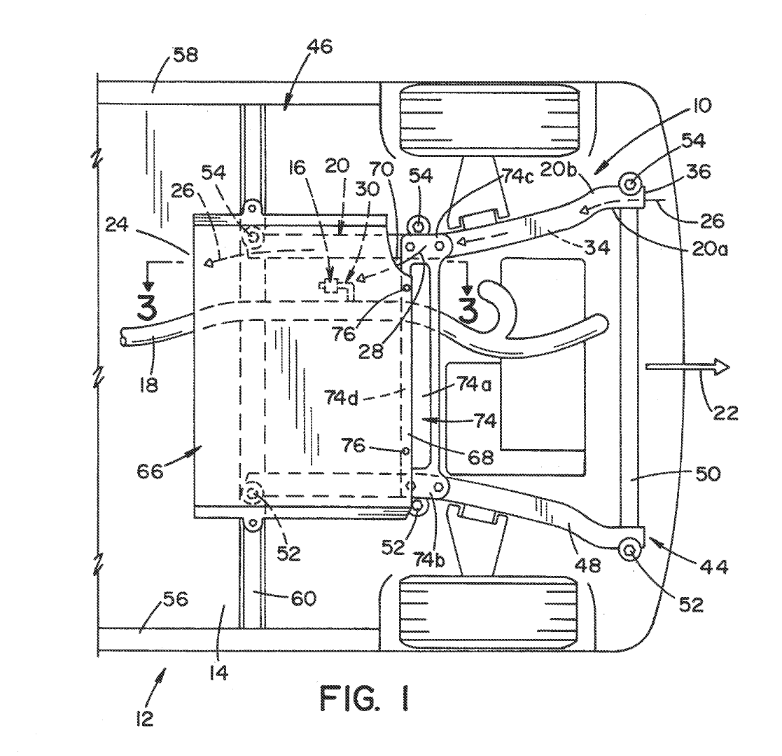

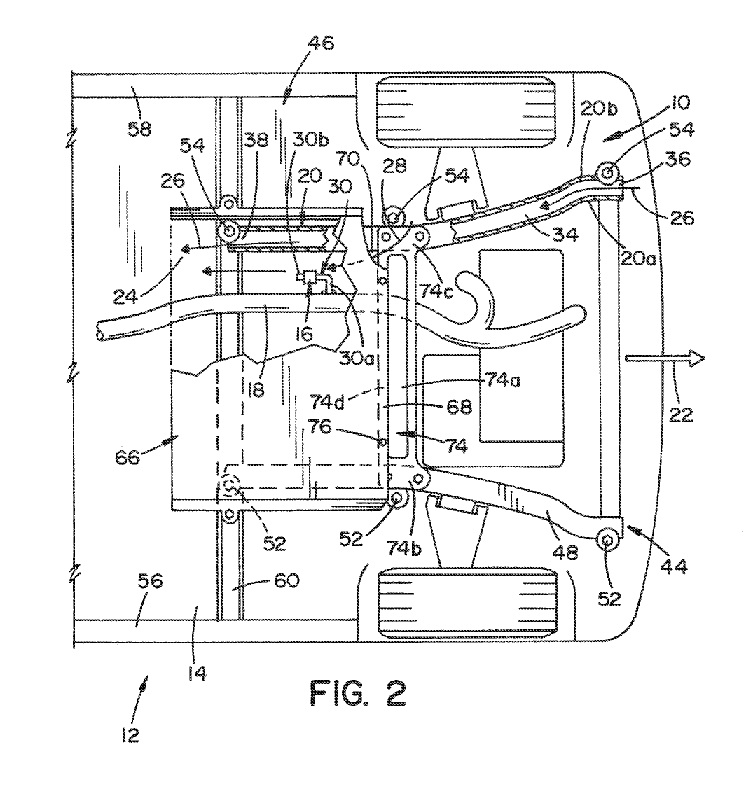

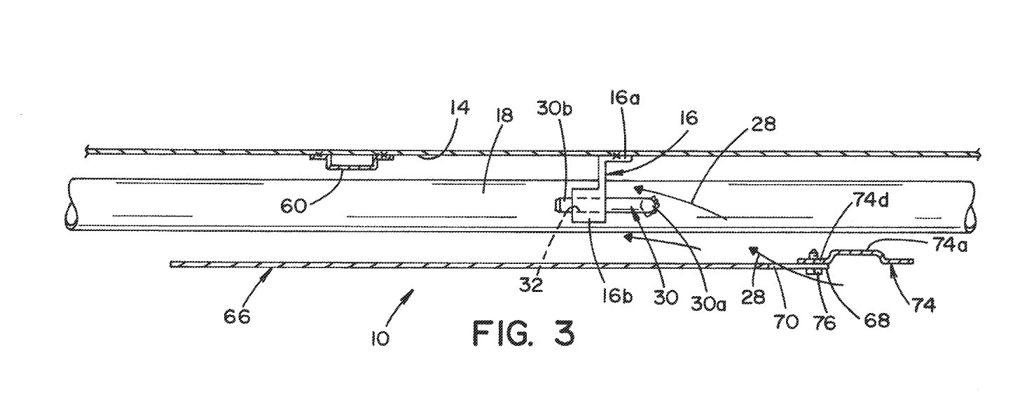

Referring now to the drawings, wherein the showings are for purposes of illustrating one or more exemplary embodiments and not for purposes of limiting same, FIGS. 1-3 illustrate an underside cooling arrangement 10 for a vehicle 12, particularly for an underside 14 of the vehicle 12. The arrangement 10 includes an underside vehicle component 16 subject to overheating. For example, the underside vehicle component 16 can be disposed in close proximity to an exhaust pipe 18 such that the mounting bracket 16 is subject to overheating due to heat gain from the exhaust pipe 18.

In the illustrated embodiment, the underside component 16 is mounted to the underside 14 of the vehicle 10 and is configured as a mounting bracket that supports an exhaust pipe 18 of the vehicle 12 in suspension from the underside 14 of the vehicle 12. It is to be appreciated, however, that the underside component could be some other vehicle component subject to overheating on the underside 14 of the vehicle 12 and/or mounted to the underside 14 of the vehicle 12. By way of example, the underside component could be a bushing or mounting (e.g., a sub-frame bushing, a rubber mount, etc.), an underside cover (e.g., a plastic undercover), a melt sheet (e.g., a passenger floor melt sheet), or any other underside component.

As will be described in more detail below, the arrangement 10 additionally includes an airflow directing member 20 that directs airflow generated when the vehicle 12 is moving in a forward direction, illustrated by arrow 22, to a location 24 rearward of the underside component 16. In particular, the airflow that is directed to the location 24 rearward of the underside component 16, which can be referred to as the primary airflow 26, creates a vacuum that draws another airflow, which can be referred to as an auxiliary airflow 28, toward, at and/or near the underside component 16 for cooling thereof. In other words, the airflow directing member 20 can direct the airflow 26 on or along the underside 14 of the vehicle 12 to the location 24 rearward of the underside vehicle component 16 to thereby create a vacuum at the location 24. This draws the auxiliary airflow 28 across the underside vehicle component 16 for cooling thereof.

The location 24 may not be an exact location on the underside 14 of the vehicle 12. Instead, the location 24 need only be positioned relative to the underside component 16, such as rearward or rearwardly spaced therefrom, for creating the vacuum that draws the auxiliary airflow 28 to, toward or near the underside component 16. In other words, the location 24 need only be specific to the extent that the vacuum created by the airflow 26 being directed thereto creates a low-pressure zone at the location 24 that pulls the auxiliary airflow 28 to the underside vehicle component 16. For example, the low-pressure zone can cause the air for the auxiliary airflow 28 to be pulled from a cold zone located along the underside 14 of the vehicle 12, such as a zone from which the auxiliary airflow 28 originates, to cool the underside vehicle component 16.

As mentioned, the underside component 16 of the illustrated embodiment is mounting bracket. As shown, when so configured, the mounting bracket 16 can mount the exhaust pipe 18 to the underside 14 of the vehicle 12. Additionally, the mounting bracket 16 can be in conductive thermal contact with the exhaust pipe 18, which can cause the bracket 16 to absorb heat from the exhaust pipe 18 and thus require sufficient cooling to maintain the bracket's integrity. Specifically, in the illustrated embodiment, the bracket 16 can include a leg portion 16a secured to the underside 14 of the vehicle 12, such as by welding, and a body portion 16b. An L-shaped bar member 30 can be interposed between the bracket 16 and the exhaust pipe 18.

In particular, and again specific to the illustrated embodiment, the bar member 30 can have a first leg 30a secured to the exhaust pipe 18, such as by welding, and can have a second leg 30b rotatably received through an aperture 32 defined by the bracket 16, and specifically by the body portion 16b of the bracket 16. The bracket 16 can secure the exhaust pipe 18 to the underside 14 of the vehicle 12 via the bar member 30 but allow relative movement between the exhaust pipe 18 and the underside 14 of the vehicle 12. Alternatively, and as will be appreciated by those skilled in the art, the underside component could be some other underside component on the underside 14 of the vehicle 12 and need not be the illustrated bracket 16. Whether the bracket 16 or some other component, the underside component can be mounted adjacent an exhaust conduit, such as illustrated exhaust pipe 18, such that the underside component absorbs heat from the exhaust component and the auxiliary airflow 28 dissipates the heat absorbed from the exhaust component.

As mentioned, and as shown in the illustrated embodiment, the airflow directing member can be the longitudinal frame component 20. The illustrated longitudinal frame component 20 defines a longitudinal passageway 34 that receives the airflow 26 through a forwardly disposed inlet or inlet aperture 36 when the vehicle is moving in the forward direction (i.e., the direction illustrated by arrow 22) and exhaust the airflow 26 received through the 36 through a rearwardly disposed outlet or outlet aperture 38 toward the location 24 rearward of the underside component 16. Accordingly, the airflow directing member 20 (a longitudinal frame component in the illustrated embodiment) can have the inlet 36 forwardly disposed for receiving the airflow 26 therein and the outlet 38 rearwardly disposed for exhausting the airflow 26 therefrom at or toward the location 24 rearward of the mounting bracket 16 to create the vacuum at the location 24 and draw the auxiliary airflow 28 across the mounting bracket 16 for cooling thereof. As illustrated, the forwardly disposed inlet or opening 36 is defined at a forward end of the longitudinal frame component 20 between sidewalls 20a, 20b of the longitudinal frame component 20 that extend an entire longitudinal extent of the longitudinal frame component 20 and thus also define the longitudinal passageway 34. Similarly, the rearwardly disposed opening 38 is defined at the rearward end of the longitudinal frame component 20 between the sidewalls 20a, 20b.

In particular, and as shown in the illustrated embodiment, the longitudinal frame component 20, or at least a substantial portion thereof, can extend generally parallel to the direction of travel of the vehicle illustrated by arrow 22. Additionally, the longitudinal frame component 20 can have a closed cross-section defining the longitudinal passageway 34 wholly within the longitudinal frame component that receives the airflow 26 through the forwardly disposed inlet aperture 36 when the vehicle is moving in the forward direction illustrated by arrow 22 and then exhaust the airflow 26 received through the inlet 36 through the rearwardly disposed outlet aperture 38.

In the illustrated embodiment, the longitudinal frame component 20 is a component of front subframe 44 on the vehicle 12 that is mounted to a main floor frame 46 of the vehicle 12. The front subframe 44 can include the longitudinal frame component 20 and another similar longitudinal frame component 48 laterally spaced from the component 20 that is a mirror image of the component 20 (i.e., the frame components 20, 48 are right and left frame components). The front subframe 44 can further include a first lateral cross braces 50 connecting front ends of the frame components 20, 48, and a second lateral cross brace 74 connecting mid-portions of the frame components 20, 48. The illustrated cross brace 74 includes a raised section 74a, mounting sections 74b, 74c which are secured against respective undersides of the longitudinal frame components 20, 48, and a rearward portion 74d, which is secured to the leading edge 68 of the aero cover 66, such as by a suitable fastener (e.g., illustrated bolts 76). The front subframe 44 can be secured to the main floor frame 46 via subframe mounts 52, 54 (e.g., three mounts for each frame component 20, 48), as will be known and understood by those skilled in the art.

In the illustrated embodiment, the main floor frame includes a pair of laterally spaced apart longitudinal frame components 56, 58, which can also be referred to as side sill frame components or members. A cross brace 60 can extend laterally between the components 56, 58, and in the illustrated embodiment, has rear ends of the front subframe 44, or more specifically rear ends of the longitudinal frame components 20, 48, mounted thereto, though this is not required. As shown, the longitudinal frame components 20, 48 of the front subframe 44 are disposed or mounted laterally inward of the adjacent side sill frame members 56, 58. Accordingly, the longitudinal frame component 20 is mounted laterally inward of the adjacent side sill frame member 58 and the longitudinal frame component 48 is mounted laterally inward of the adjacent side sill frame member 56.

The arrangement 10 can further include an aero cover 66, also referred to herein as an undercover, disposed over a portion of the underside 14 of the vehicle 12 for improving aerodynamics of the vehicle 12. In the illustrated embodiment, the aero cover 66 is also disposed over the underside component 16. In particular, the aero cover 66 can be mounted to the underside 14 of the vehicle 12 over the underside vehicle component 16 so as to substantially inhibit airflow passing under the vehicle from cooling the underside vehicle component 16. Thus, the aero cover 66 substantially prevents the general longitudinal airflow passing along the underside 14 of the vehicle 12 (i.e., normal airflow forced between the vehicle underside 14 and the roadway on which the vehicle 12 is travelling) from passing over the underside vehicle component 16

In the illustrated embodiment, a forward end 68 of the aero cover 66 is spaced slightly apart from the adjacent portion of the underside 14, which limits the amount of airflow that can enter beneath the aero cover 66 (i.e., between the aero cover 66 and the underside 14). Though not shown, the cover 66 could also be configured to be substantially closed at its forward end 68, or at least closed directly forward of the component 16, to thereby prevent the longitudinal airflow beneath the vehicle 12 from entering between the underside 14 of the vehicle 12 and the aero cover 66. In either arrangement, the effect is that cooling of the underside vehicle component 16 is inhibited. For example, in the illustrated embodiment, the aero cover 66 is disposed wholly over the underside component 16 and substantially prevents an underside airflow passing beneath the vehicle 12 when moving in the forward direction shown by arrow 22 from cooling the underside component 16. As is also shown, an inlet 70 can be defined by the aero cover 66 that is laterally offset relative to the underside component 16. The auxiliary airflow 28 can be drawn through the inlet 70 for cooling the underside component 16.

According to the illustrated arrangement 10, a method for cooling an underside component, such as underside component 16, is provided. In the method, a primary airflow 26 can be directed to the location 24 disposed rearward of the underside vehicle component 16. This can create a vacuum at the location 24 with the airflow 26 directed thereto. As a result, cooling air via auxiliary airflow 28 is drawn to the location 24 with the vacuum and thereby is also drawn to, toward and/or adjacent the underside vehicle component 16. In the illustrated arrangement 10, the cooling air is the auxiliary airflow 28 that is drawn laterally across the underside vehicle component 16 and originates thought the opening 70 in the aero cover 66.

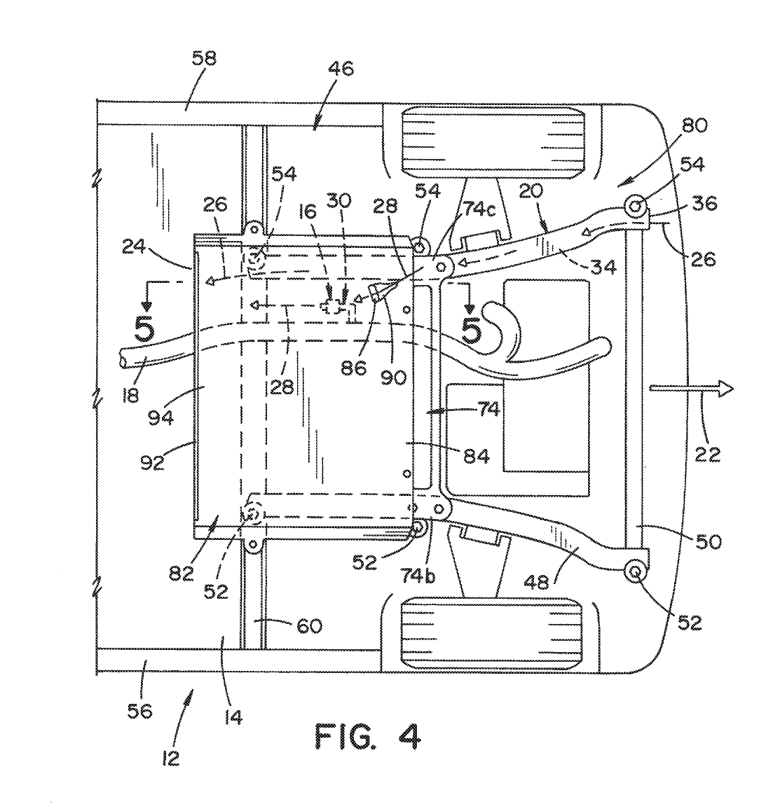

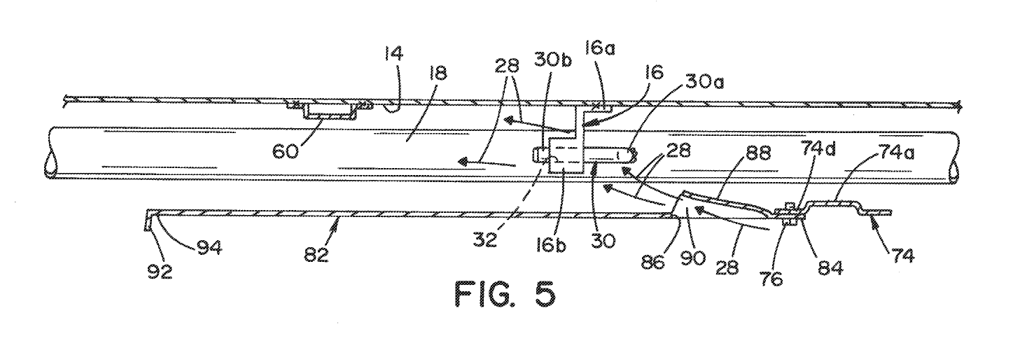

Referring now to FIGS. 4 and 5, another underside cooling arrangement 80 is illustrated. Except as indicated below, the arrangement 80 is the same or similar to the arrangement 10 and thus like referenced numerals are used to identify like parts and only the differences between the arrangements 10 and 80 will be described herein. In the arrangement 80, the aero cover 66 is replaced by an aero cover 82. The leading edge or forward end 84 of the aero cover 82 extends along an entire lateral width of the aero cover 82 and thus does not include the same inlet 70 as defined at a corner portion of the aero cover 66. Instead, an inlet 86 is defined by the aero cover 82 spaced rearwardly from the leading edge 84.

If desired, and as shown in the illustrated embodiment, the inlet 86 can be laterally offset, at least slightly, relative to the underside component 16. Like the inlet 70, the inlet 86 allows the auxiliary airflow 28 to be drawn therethrough for cooling the underside component 16. In addition, the arrangement 80 can include a duct member 88 disposed on or formed integrally as part of the aero cover 82. The duct member 88 can extend from the inlet 86 and define an air channel 90 for routing the auxiliary airflow 28 toward the underside component 16. The duct member 88 allows for more precise direction and control of the auxiliary airflow 28 being pulled in due to the pressure differential caused by the primary airflow 26 being directed to location 24.

In addition, the arrangement 80 can further include an air dam member or strake 92 disposed at or adjacent a trailing edge 94 of the aero cover 82 for increasing the low pressure area behind the underside component 16 (i.e., at the back of the aero cover 82) and thereby multiplying the effectiveness of the duct member 88. In the illustrated embodiment, the strake 92 is formed integrally with the aero cover 82, depends downward at approximately the trailing edge 94 of the aero cover 82 and spans laterally along nearly an entire lateral width of the aero cover 82. Having the strake 92 at or adjacent the trailing edge 94 of the aero cover 82 assists in creating the vacuum effect at the location 24 and advantageously increases the draw of the auxiliary airflow 28 through the inlet 70 and past the underside component 16 for cooling thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An underside cooling arrangement for a vehicle, comprising:
an underside component mounted to the underside of the vehicle; and
an airflow directing member that directs a primary airflow generated when the vehicle is moving in a forward direction to a location rearward of the underside component, the primary airflow that is directed to the location rearward of the underside component creating a vacuum that draws an auxiliary airflow that is separate from the primary airflow near the underside component for cooling thereof.

2. The underside cooling arrangement of claim 1 wherein the underside component is mounted adjacent an exhaust conduit such that the underside component absorbs heat from the exhaust component, the auxiliary airflow dissipating the heat absorbed from the exhaust component.

3. The underside cooling arrangement of claim 2 wherein the underside component is a mounting bracket and the exhaust component is an exhaust pipe, the mounting bracket mounting the exhaust pipe to the underside of the vehicle and in conductive thermal contact with the exhaust pipe.

4. The underside cooling arrangement of claim 3 wherein the airflow directing member is a longitudinal frame component defining a longitudinal passageway therein that receives the primary airflow through a forwardly disposed inlet aperture when the vehicle is moving in the forward direction and exhausts the primary airflow received through the inlet through a rearwardly disposed outlet aperture toward the location rearward of the underside component.

5. The underside cooling arrangement of claim 1 wherein the vacuum creates a low pressure zone that pulls the auxiliary airflow from a cold zone located along the underside of the vehicle to cool the underside vehicle component.

6. The underside cooling arrangement of claim 1 wherein the airflow directing member is a longitudinal frame component extending generally parallel to a direction of travel of the vehicle, the longitudinal frame component having a closed cross-section defining a longitudinal passageway within the longitudinal frame component that receives the primary airflow through a forwardly disposed inlet aperture when the vehicle is moving in the forward direction and exhausts the primary airflow received through the inlet through a rearwardly disposed outlet aperture.

7. An underside cooling arrangement for a vehicle, comprising:
an underside component mounted to the underside of the vehicle;
an airflow directing member that directs airflow generated when the vehicle is moving in a forward direction to a location rearward of the underside component, the airflow that is directed to the location rearward of the underside component creating a vacuum that draws an auxiliary airflow near the underside component for cooling thereof; and
an aero cover disposed over a portion of the underside of the vehicle for improving aerodynamics of the vehicle, the aero cover also disposed over the underside component.

8. The underside cooling arrangement of claim 7 wherein the aero cover is disposed wholly over the underside component and substantially prevents an underside airflow passing under the vehicle when moving in the forward direction from cooling the underside component.

9. The underside cooling arrangement of claim 8 wherein an inlet is defined by the aero cover that is laterally offset relative to the underside component, the auxiliary airflow drawn through the inlet for cooling the underside component.

10. The underside cooling arrangement of claim 9 wherein a small gap is defined between a forward end of the aero cover and the underside of the vehicle, the gap sized that airflow passing between the aero cover and the underside of the vehicle is inhibited from cooling the underside component.

11. The underside cooling arrangement of claim 10 further including a duct member disposed on the aero cover, the duct member extending from the inlet and defining an air channel for routing the auxiliary airflow toward the underside component.

12. The underside cooling arrangement of claim 7 further including a strake disposed adjacent a leading edge of the aero cover for increasing the vacuum.

13. A method for cooling an underside vehicle component, comprising:
directing a primary airflow to a location rearward of the underside vehicle component while bypassing the underside vehicle component;
creating a vacuum at the location with the primary airflow directed thereto; and
drawing cooling air that is separate from the primary airflow to the underside vehicle component with the vacuum.

14. The method of claim 13 wherein the cooling air is an auxiliary airflow drawn laterally across the underside vehicle component.

15. A cooling arrangement for an underside of a vehicle, comprising:
an underside vehicle component subject to overheating; and
an airflow directing member directing an airflow on the underside of the vehicle to a location rearward of the underside vehicle component while bypassing the underside vehicle component to thereby create a vacuum at the location and draw an auxiliary airflow laterally across the underside vehicle component for cooling thereof.

16. The cooling arrangement of claim 15 wherein the underside vehicle component is a mounting bracket supporting an exhaust pipe of the vehicle in suspension from the underside of the vehicle, the mounting bracket disposed in close proximity to the exhaust pipe such that the mounting bracket is subject to overheating due to heat gain from the exhaust pipe.

17. The cooling arrangement of claim 16 wherein the airflow directing member is a longitudinal frame component of the vehicle having a forwardly disposed opening for receiving the airflow therein and a rearwardly disposed opening for exhausting the airflow from the longitudinal frame component at the location rearward of the mounting bracket to create a vacuum at the location and draw the auxiliary airflow across the mounting bracket for cooling thereof.

18. The cooling arrangement of claim 15 wherein the airflow directing member is a longitudinal frame component of the vehicle having a forwardly disposed opening for receiving the airflow therein and a rearwardly disposed opening for exhausting the airflow from the longitudinal frame component at the location rearward of the underside of vehicle component.

19. The cooling arrangement of claim 18 wherein the longitudinal frame component is a component of a front subframe on the vehicle that is mounted to a main floor frame of the vehicle, the longitudinal frame component mounted laterally inward of an adjacent side sill frame member, and further wherein the forwardly disposed opening is defined at a forward end of the longitudinal frame member between side walls of the longitudinal frame component that extend an entire longitudinal extent of the longitudinal frame component, and the rearwardly disposed opening is defined at a rearward end of the longitudinal frame member between said side walls.

20. The cooling arrangement of claim 15 further including:
an aero undercover mounted to the underside of the vehicle over the underside vehicle component so as to substantially inhibit longitudinal airflow passing along the underside of the vehicle from cooling the underside vehicle component.
